(19) United States
(12) Patent Application Publication
(10) Pub. No.: US 2025/0190984 A1
(43) Pub. Date: Jun. 12, 2025

(54) OFFLINE INTERACTION BLOCKCHAIN SYSTEM AND METHOD

(71) Applicant: Visa International Service Association, San Francisco, CA (US)

(72) Inventors: Mahdi Zamani, Mercer Island, WA (US); Ranjit Kumaresan, Fremont, CA (US); Srinivasan Raghuraman, Cambridge, MA (US); Mohammad Mohsen Minaei Bidgoli, San Jose, CA (US); Andrew Beams, Christiansburg, VA (US)

(73) Assignee: Visa International Service Association, San Francisco, CA (US)

(21) Appl. No.: 18/846,147

(22) PCT Filed: Mar. 17, 2023
(86) PCT No.: PCT/US2023/015562

§ 371 Date: Sep. 11, 2024

Related U.S. Application Data
(60) Provisional application No. 63/321,617, filed on Mar. 18, 2022.
(60) Provisional application No. 63/410,153, filed on Sep. 26, 2022.

(51) Int. Cl. G06Q 20/38

(52) U.S. Cl. CPC G06Q 20/389; G06Q 20/3825

(57) ABSTRACT

A method includes receiving, by a user device, an interaction request message for an interaction. The interaction request message comprises a requested amount from a resource provider computer. A secure element on the user device selects between an offline balance and an offline amount of program tokens stored in the secure element. The offline amount of program tokens can be selected. The secure element on the user device can deduct the requested amount from the offline amount of program tokens. The user device can complete the interaction with the resource provider computer.

### CROSS-REFERENCES TO RELATED APPLICATIONS

The present application is a PCT application of and claims priority to U.S. Provisional Application No. 63/321,617, filed Mar. 18, 2022, and U.S. Provisional Application No. 63/410,153, filed Sep. 26, 2022, which are incorporated herein by reference in their entirety.

### BACKGROUND

Digital payments traditionally rely on online communications with intermediaries such as banks and payment processors to authorize payment transactions. While such networks are usually designed to be highly available with continuous up-time, a user may occasionally experience little or no access to these networks. Existing solutions that allow payments to happen offline between two clients could only solve this problem partially, falling short of providing for the convenience and the resiliency of physical fiat payments. Namely, these solutions expect either (1) the recipient to accept the risk that the sender may not have sufficient funds available online, or (2) the same funds may be spent offline only once unless the recipient claims them online. These assumptions essentially make the circulation of funds dependent on the clients being online, contradicting the real-time nature of physical fiat payments that make them convenient.

Additionally, supplemental nutrition assistance programs, along with other programs, are available to those in need. Users currently have benefits loaded into an account on a card each month from a governmental agency for use in an electronic benefits transfer. The benefits can then be utilized to obtain authorized resources at authorized resource providers.

However, such disbursement of benefits can be problematic. For example, cards can be lost or destroyed. Additionally, users must disclose that they are using the assistance program to the resource provider when obtaining the resource.

Embodiments of the disclosure address this problem and other problems individually and collectively.

### SUMMARY

One embodiment is related to a method comprising: receiving, by a user device, an interaction request message for an interaction, the interaction request message comprising a requested amount from a resource provider computer; selecting, by a secure element on the user device, between an offline balance and an offline amount of program tokens stored in the secure element, wherein the offline amount of program tokens is selected; deducting, by the secure element on the user device, the requested amount from the offline amount of program tokens; and completing, by the user device, the interaction with the resource provider computer.

Another embodiment is related to a user device comprising: a processor; and a computer-readable medium coupled to the processor, the computer-readable medium comprising code executable by the processor for implementing a method comprising: receiving an interaction request message for an interaction, the interaction request message comprising an amount from a resource provider computer; selecting, by a secure element on the user device, between an offline balance and an offline amount of program tokens stored in the secure element, wherein the offline amount of program tokens is selected; deducting, by the secure element on the user device, the amount from the offline amount of program tokens; and completing the interaction with the resource provider computer based on the amount.

Another embodiment is related to a method comprising: generating, by a resource provider computer, an interaction request message for an interaction, the interaction request message comprising an amount; transmitting, by the resource provider computer, the interaction request message to a user device, wherein a secure element on the user device selects between an offline balance and an offline amount of program tokens stored in the secure element, and wherein the secure element on the user device deducts the amount from the offline amount of program tokens and generates an interaction response message; receiving, by the resource provider computer, the interaction response message from the user device, wherein the interaction response message comprises an amount equal to the requested amount; and completing, by resource provider computer, the interaction with the user device based on the amount.

Further details regarding embodiments of the disclosure can be found in the Detailed Description and the Figures.

### BRIEF DESCRIPTION OF THE DRAWINGS

FIG. 1 shows a block diagram of an interaction processing system according to embodiments.

FIG. 2 shows a block diagram of components of a user device according to embodiments.

FIG. 3 shows a block diagram of components of a resource provider computer according to embodiments.

FIG. 4 shows an illustration of an overview of a user device that hosts a trusted execution environment according to embodiments.

FIG. 5 shows a flow diagram of an offline interaction method according to embodiments.

FIG. 6 shows a flow diagram of a program registration method according to embodiments.

FIG. 7 shows a flow diagram of an offline interaction system registration method according to embodiments.

FIG. 8 shows a flow diagram of a program token creation method according to embodiments.

FIG. 9 shows a flow diagram of transferring program tokens to an offline balance according to embodiments.

FIG. 10 shows a flow diagram of an offline interaction method using program tokens according to embodiments.

FIG. 11 shows a flow diagram of transferring program tokens to an online balance according to embodiments.

### DETAILED DESCRIPTION

Prior to discussing embodiments of the disclosure, some terms can be described in further detail.

A “user device” may be a device that is operated by a user. Examples of user devices may include a mobile phone, a smart phone, a card, a personal digital assistant (PDA), a laptop computer, a desktop computer, a server computer, a vehicle such as an automobile, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. There are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network.

A “user” may include an individual. In some embodiments, a user may be associated with one or more personal accounts and/or mobile devices. The user may also be referred to as a cardholder, account holder, or consumer in some embodiments. In some embodiments, a resource provider can be a user and may operate a user device.

A “secure element” can include an element that is secure. A secure element can include a cryptographically secure computer-on-a-chip or microprocessor. A secure element can conduct cryptographic operations and may be embedded in a packaging with one or more physical security measures. In some embodiments, a secure element can include a component that can perform a function securely. A secure element may be a memory that securely stores data, such that its access is protected. A secure element can include a trusted execution environment on a secure area of a processor. An example of a secure element is a universal integrated-circuit card (UICC). Another example of a secure element is an embedded secure element, an embedded hardware component in a larger mechanical or electrical system. Another example of a secure element is a hardware security module (HSM), which is a physical computing device that can safeguard and manage cryptographic keys for authentication and provide crypto-processing functions.

A “trusted execution environment” (TEE) can include a secure area. A trusted execution environment can be a software stack stored on a read-only memory (ROM). A trusted execution environment can be included within a secure element. A trusted execution environment software stack can include of a set of resources to access the secure element, a trusted operating system (TOS) that provides a developer access to the underlying secure element, and one or more trusted applications (TA) that implement application-specific functionalities within the trusted application environment.

In some embodiments, a trusted execution environment can be an isolated execution environment that provides security features such as isolated execution, integrity of applications executing with the trusted execution environment, along with confidentiality of their assets. A trusted execution environment can offer an execution space that provides a higher level of security for trusted applications running on the device than a rich operating system and more functionality than a secure element alone.

A “trusted application” can include an application that is implemented within a trusted execution environment. A trusted application may perform specific functionalities. A trusted application can be paired with an application-specific client application (CA) that resides outside of the isolated trusted execution environment space and provides user-facing functionalities by interacting with the trusted application through the trusted operating system.

An “interaction” may include a reciprocal action or influence. An interaction can include a communication, contact, or exchange between parties, devices, and/or entities. Example interactions include a transaction between two parties and a data exchange between two devices. In other embodiments, an interaction can include a payment transaction in which two devices can interact to facilitate a payment.

“Interaction data” can include data related to and/or recorded during an interaction. In some embodiments, interaction data can be transaction data of the network data. Transaction data can comprise a plurality of data elements with data values.

An “amount” can include a quantity of something. An amount can include a total of a thing or things in number, size, value, or extent.

An “offline amount” can include a quantity of something that may be used when offline (i.e., when direct communication with a server computer is not present). An offline amount can be stored locally on a user device. For example, an offline amount can be stored in a secure element on a user device. An offline amount can be utilized during an offline interaction. For example, a first user can select to provide an amount to a second user while the first user's device is not connected to or in communication with a server computer (e.g., is not online). The first user device can deduct the amount to be provided from the offline amount stored in the secure element.

An “online amount” can include a quantity of something that may be used when online. An online amount can be stored on a server computer. For example, a plurality online amounts associated with a plurality of users can be stored on a server computer and/or a database maintained by the server computer. In some embodiments, an online amount can be utilized during an online interaction. In other embodiments, an amount from the online amount on a server computer can be transferred to an offline amount on a user device. For example, a server computer can deduct an amount from an online amount associated with a first user, then provide the amount in a secure message to a first user device. The first user device can include the received amount into an offline amount stored in a secure element.

A “resource provider” may be an entity that can provide a resource such as goods, services, information, and/or access. Examples of resource providers includes merchants, data providers, transit agencies, governmental entities, venue and dwelling operators, etc.

The term “verification” and its derivatives may refer to a process that utilizes information to determine whether an underlying subject is valid under a given set of circumstances. Verification may include any comparison of information to ensure some data or information is correct, valid, accurate, legitimate, and/or in good standing.

The term “public/private key pair” may include a pair of linked cryptographic keys generated by an entity. The public key may be used for functions such as encrypting a message to send to the entity or for verifying a digital signature which was supposedly made by the entity. The private key may be used for functions such as decrypting a received message or applying a digital signature. The public key can be authorized by a certificate authority, which can store the public key in a database and distribute it to any other entity which requests the public key. The private key can be kept in a secure storage medium and will usually only be known to the entity. However, the cryptographic systems described herein may feature key recovery mechanisms for recovering lost keys and avoiding data loss. Public and private keys may be in any suitable format, including those based on Rivest-Shamir-Adleman (RSA) or elliptic curve cryptography (ECC).

A “digital signature” may include a type of electronic signature. A digital signature may encrypt documents with digital codes that can be difficult to duplicate. In some embodiments, a digital signature may refer to the result of applying an algorithm based on a public/private key pair, which allows a signing party to manifest, and a verifying party to verify, the authenticity and integrity of a document. The signing party acts by means of the private key and the verifying party acts by means of the public key. This process certifies the authenticity of the sender, the integrity of the signed document and the so-called principle of nonrepudiation, which does not allow disowning what has been signed. A certificate or other data that includes a digital signature by a signing party is said to be “signed” by the signing party.

A “certificate” or “digital certificate” may include an electronic document and/or data file. In some cases, the certificate or the digital certificate may be a device certificate. In some embodiments, a digital certificate may use a digital signature to bind a public key with data associated with an identity. A digital certificate may be used to prove the ownership of a public key. The certificate may include one or more data fields, such as the legal name of the identity, a serial number of the certificate, a valid-from and valid-to date for the certificate, certificate related permissions, etc. A certificate may contain a “valid-from” date indicating the first date the certificate is valid, and a “valid-to” date indicating the last date the certificate is valid. A certificate may also contain a hash of the data in the certificate including the data fields. A certificate can be signed by a certificate authority.

A “certificate authority” may include an entity that issues digital certificates. A certificate authority may prove its identity using a certificate authority certificate, which includes the certificate authority's public key. A certificate authority certificate may be signed by another certificate authority's private key or may be signed by the same certificate authority's private key. The latter is known as a self-signed certificate. The certificate authority may maintain a database of all certificates issued by the certificate authority. The certificate authority may maintain a list of revoked certificates. The certificate authority may be operated by an entity, for example, a processing network entity, an issuer, an acquirer, a central bank etc.

A “program token” can include a digital representation of a value. Program tokens can be exchanged for goods and services. Program tokens can be minted by a program computer from central bank digital currency at the behest of a central bank. Program tokens can be issued by a program computer to a user. Users can spend program tokens during interaction with merchants. A program token can be represented in a form on an EIP20 token.

A “smart contract” can include a program. A smart contract can be a digital contract stored on a blockchain. A smart contract can be automatically executed when predetermined requirements are met. Smart contracts on a blockchain can store a state and can execute computations. An interaction with a smart contract can invoke other smart contracts.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or Xscale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

An offline interaction system can allow a user (e.g., a customer) to make digital payments to another user (e.g., a resource provider) while both users' devices are temporarily offline from intermediary computers (or even the Internet). Embodiments relate to an offline payment system (OPS) protocol that allows point-to-point authorization of offline payments using cryptographic techniques (e.g., public key infrastructure) to significantly reduce the onboarding overhead of participants compared to existing digital payment systems. Once provisioned, OPS digital wallets can securely sign and transmit interaction messages directly with each other over any communication channel they prefer without requiring an intermediary to authorize and settle the interaction. Receiving OPS digital wallets can submit signed interaction messages that were received when offline to an authorized third party. The authorized third party can guarantee settlement of those interactions in order to allow the receiving OPS digital wallets to withdraw funds from the offline payment system. Additionally, OPS allows clients to recover their offline money in case of device loss.

Embodiments further provide for systems and methods for how OPS can enable offline cryptocurrency payments in a hybrid setting, where a smart contract enforces ledger requirements in a trustless fashion, while the trusted server provisions TEEs during a one-time setup. Additionally, embodiments provide a hierarchical trust model to allow offline payments to happen between clients that were provisioned by different servers.

Traditionally, digital payments are made over account-based systems, where the ownership of funds is tied to user identities. Over the last few years, there has been growing interest in digital currency payment systems based on tokens that exist as an object, where the ownership of money is determined by user's access to a private cryptographic key. Most notably, central banks across the world are exploring the issuance of token-based central bank digital currencies (CBDC) that would enable consumers and businesses to access a new form of central bank money as a bearer asset akin to digital cash.

Existing card payment networks can provide some form of offline payments for situations where the acceptance device (e.g., a card terminal) cannot connect to payment providers for authorization. However, these payments require the merchant to bear the risk that the payer may not have sufficient funds to fulfill the transaction.

Embodiments can utilize a trusted execution environment (TEE), an isolated area of a main processor that guarantees code and data loaded into them is protected with respect to integrity and confidentiality. Being validated and provisioned through an initial trusted setup with a remote, trusted server, a TEE is then allowed to store money and digitally sign payment objects using a private key that is stored securely inside the TEE.

A major limitation of the existing offline payment solutions is that they do not allow a client to spend the money they receive as part of an offline payment immediately. For example, the client has to go online to communicate with a remote, trusted third party to first claim the received funds and then move them to the client's TEE for future offline payments. This is a large departure from the convenience that physical fiat currencies provide, which is the real-time availability of funds.

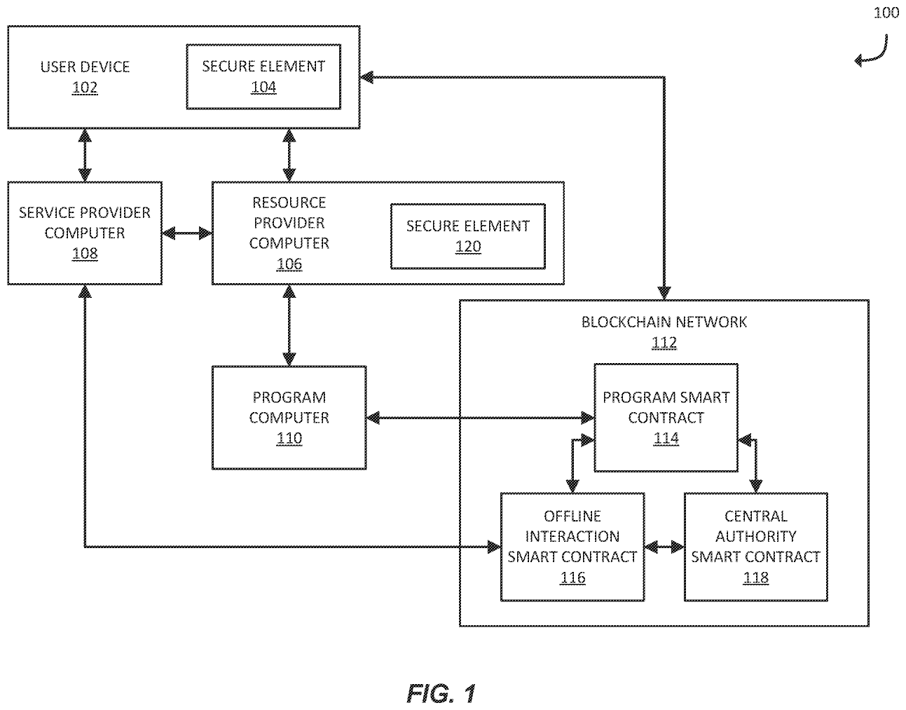

Prior to discussing the system described in reference to FIG. 1, a brief overview of offline payments will be provided along with a description of various methods for the OPS system. Consider two clients A and B who hold online accounts with a server S. An account can be assumed to maintain information about the amount of money (e.g., balance) that the client holds at S. A goal of the OPS protocol is to allow client A (e.g., the sender) to pay client B (e.g., the receiver) an amount of money denoted by x from A's account with S without either client communicating with S during the payment. It can be assumed that A (or any other client who wishes to send money) owns a secure device DA that can securely store data and execute code via a TEE. However, it is not required that B (or any other client who only wants to receive money) to own a secure device.

Setup Protocol. In the OPS protocol, both clients can register with S during a one-time, online setup to establish asymmetric cryptographic keys that are later used to issue and verify offline payments. The online setup also allows client A to initialize their TEE jointly by the server S and device DA's manufacturer. The TEE setup consists of three phases: (1) remote attestation to allow either the manufacturer or the server S to remotely verify the validity of the TEE stack; (2) TA provisioning to allow either the manufacturer or the server S to securely deploy a TA inside TEE; and (3) TA registration to allow the TA to establish a signing key pair, register it with the server S, and obtain a certificate attesting to the validity of the key pair.

Deposit Protocol. The client A can initially deposit funds into their secure device when they are online to be able to send offline payments later. Namely, client A requests the server S to deposit an amount of x money from their online balance stored at the server S into the offline balance stored in TA. The server S responds with a signature on showing that x was deducted from client A's online balance. The client TA verifies the signature with the server's public verification key and adds x to the offline balance stored in the TA.

Offline Payment Protocol. An offline payment is initiated by the receiver (client B) who sends a payment request to client A, including client B's certificate (e.g., user device B's certificate) in the request. Upon receiving the request, client A invokes TA:Pay to securely deduct the payment amount from TA's balance and create a signed payment message P containing the payment amount and the certificates of both clients. Client A sends the payment message P to client B who verifies client A's signature and the certificate, and checks that the payment contains client B's certificate as the recipient. If all checks pass, client B accepts the payment and stores the payment message P on the device. Note that by deducting the payment amount from client A's balance (which is stored on the TEE storage), the TEE prevents double spending of that amount.

Claim Protocol. If the client B wants to add the amount of the payment message P that they received offline from client A to their online balance stored at the server S, client B can invoke the Claim protocol in which the server S verifies the validity of the payment message P and checks if it was not previously marked as spent using a payment log stored by the server S. If all checks pass, the server S adds the amount of the payment message P to the client B's online balance and adds the payment message P to the log.

Collect Protocol. In the case where the client B also has a TEE with TB set up similar to what was described before. If the client B attempts to make an offline payment out of the amount that it previously received in the payment message P from the client A without going online, then the client B can invoke the Collect protocol to add the money in the payment message P into TB's balance. This allows the client B to spend the funds offline in exactly the same way that the client A made the offline payment P.

Withdraw Protocol. If the client A attempts to move funds from the TA to client A's online balance stored at the server S, then the client A can invoke the Withdraw protocol which invokes TA:Withdraw to deduct the funds from the TA and return a message signed with the TA's signing key. The client A then forwards the signed withdraw message to the server S who adds the fund to client A's online balance after verifying the signature.

Embodiments also provide for replay and rollback protection. To protect against malicious intermediaries (such as a malicious UA) replaying the messages exchanged between the server S and the TA as well as between the client A and the client B, each party maintains monotonically increasing counters that are incremented after every round of communication between a pair of parties. Both the server S and the TA (as well as the client A and the client B) include the latest value of their counter in their signed messages so that the receiver can verify the uniqueness and ordering of all messages according to their local counter which is synchronized after every exchange.

Embodiments can utilize smart contracts. A smart contract can perform various functionalities herein described as being performed by a service provider computer. A smart contract is a computer program (e.g., processing software) that is intended to automatically execute, control or document legally relevant events and actions according to the terms of a contract or an agreement. A few advantages of a smart contract is the reduction of need in trusted intermediators, arbitrations and enforcement costs, fraud losses, as well as the reduction of malicious and accidental exceptions.

As described thus far, embodiments can utilize a trusted server (e.g., a service provider computer) for both provisioning the OPS TA and performing online interactions. Embodiments can separate these two tasks of the service provider computer and can implement the online interaction portion using a smart contract. In some cases, the whole service provider computer is not simply replaced with a smart contract because during provisioning process the service provider computer uses its signing key to authorize each OPS TA for offline interactions. Since all information stored in a smart contract is public, it is typically impossible to store signing keys in the contract state. Thus, embodiments adopt a design where the Deposit, Withdraw, and Claim functions are delegated to a smart contract.

Thus, for example, during a claim method (e.g., after a second user device receives an interaction response message from a first user device), the second user device can provide the interaction response message to processing software of the smart contract. The processing software can be located at the service provider computer. The processing software can update a first online amount associated with the first device and a second online amount associated with the second device based on the amount included in the interaction response message.

During TA registration, when an OPS TA sends a TARegister to the service provider computer, the service provider computer responds with a certificate [cert]. However, when a smart contract is utilized, the service provider computer can also send the OPS TA identity (e.g., the TA verification key) to the smart contract. In addition, the Withdraw and Claim methods can be modified so that the OPS TA can now send the Withdraw and Claim to the smart contract instead of the service provider computer. Since the smart contract has the verification key of the OPS TA, the smart contract can simply verify the Withdraw and Claim to complete the Withdraw and Claim. However, the deposit verification is more a subtle process that is described in further detail herein.

During the Deposit protocol, upon receiving the DepositConfirmed message from the service provider computer, as described herein, the OPS TA validates the message for correctness using the verification key of the service provider computer and updates its offline balance. Since the smart contract cannot typically sign messages, embodiments can instead implement blockchain inclusion proofs to convince the OPS TA of any event on the blockchain. Note that these proofs need to convince the OPS TA that the deposit transaction was executed correctly.

One technical problem is that there can be different types of blockchain inclusion proofs that may need to interact with the smart contract and the user device. For example, blockchain inclusion proofs differ based on the underlying architecture of the ledger protocol where the smart contract is hosted. These distributed ledgers can be broadly classified into two categories: 1) Nakamoto consensus and 2) Byzantine fault tolerant (BFT) consensus.

Nakamoto consensus protocols, such as proof-of-work blockchains, typically rely on the longest/heaviest chain to resolve potential forks. In contrast BFT blockchains, such as Algorand and Hotstuff, participating nodes (e.g., participants) typically decide on a block when a group of signers reaches a unanimous vote to include the block in the ledger. This signer group can include either a subset of participants or all of them.

The original Bitcoin paper describes an efficient inclusion proof technique, known as simplified payment verification (SPV), where the proof only includes the header chain instead of the entire ledger. As a result, in Bitcoin, the proof only requires 80 bytes of information per block instead of 1 MB per block.

Although relying only on block headers reduces the verification overhead of inclusion proofs, it still incurs a significant overhead, particularly when considering the fact that this overhead increases linearly with the number of blocks.

This has already become a major concern in Ethereum due to its significantly shorter block interval than Bitcoin (15 seconds vs. 10 minutes) and significantly larger block headers (508 bytes vs. 80 bytes).

To reduce this proof size for Nakamoto blockchains, proposals for sublinear light clients were introduced and typically rely on the notion of superblocks, blocks that solve a more difficult PoW puzzle than the current target puzzle. Proofs of proof of work (PoPOW) based on superblocks were introduced and formalized as an interactive proof mechanism. PoPoWs allow a prover to convince a verifier with a high probability in logarithmic time and communication that a chain contains a sufficient amount of work.

To overcome these challenges, Bunz et al. propose Fly-Client [B. Bunz, L. Kiffer, L. Luu, and M. Zamani, “Flyclient: Super-light clients for cryptocurrencies,” in 2020 IEEE Symposium on Security and Privacy (SP). IEEE, 2020, pp. 928-946.]. FlyClient requires downloading only a logarithmic number of block headers to verify the validity of the chain. Once the chain is verified, the client needs to store only a single block to efficiently verify the inclusion of any transaction on the blockchain. The FlyClient protocol is a non-interactive PoPOW but overcomes the limitations of the superblock based NIPoPOW protocol.

Thus, FlyClient and/or other efficient Nakamoto type consensus protocols can be utilized to provide inclusion proofs to a user device from the smart contract when a deposit is successfully added to the blockchain.

BFT based ledger protocols typically consist of nodes (X) that participate in a consensus protocol to decide on each block individually. In many BFT based ledgers the set X rarely changes and is known a priori. However, in some BFT protocols X can change every block in a verifiable manner.

When it comes to efficient inclusion proofs, we are not aware of any works that address this technical problem of providing efficient inclusion proofs for a deposit for BFT ledgers. A first technical solution will be described where the set of nodes participating in the consensus protocol is fixed, which will be described herein.

Embodiments provide for a system that allows trusted hardware to initiate deposits out of a smart contract on a blockchain to transfer an amount from an online amount at a server to an offline amount at a user device. Embodiments can further allow for verifying deposit transactions that happen on the blockchain.

FIG. 1 shows a system 100 according to embodiments of the disclosure. The system 100 comprises a user device 102 comprising a secure element 104, where the system 100 further includes a resource provider computer 106 comprising a secure element 120, a service provider computer 108, a program computer 110, and a blockchain network 112 that includes a program smart contract 114, an offline interaction smart contract 116, and a central authority smart contract 118.

The user device 102 can be in operative communication with the service provider computer 108, the resource provider computer 106, and the blockchain network 112. The service provider computer 108 can be in operative communication with the resource provider computer 106 and the blockchain network 112 (e.g., communicating with the offline interaction smart contract 116). The resource provider computer 106 can be in operative communication with the program computer 110, which can be in operative communication with the blockchain network 112 (e.g., communicating with the program smart contract 114).

For simplicity of illustration, a certain number of components are shown in FIG. 1. It is understood, however, that embodiments of the invention may include more than one of each component. In addition, some embodiments of the invention may include fewer than or greater than all of the components shown in FIG. 1.

Messages between the devices illustrated in the system 100 of FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The user device 102 can include the secure element 104. The user can utilize the user device 102 to perform an interaction (e.g., a transaction, a data transfer, etc.) with the resource provider computer 106. The user device 102 can perform a transaction with the resource provider computer 106 when the user device 102 and the resource provider computer 106 are offline (e.g., not connected to the service provider computer 108).

The secure element 104 can include a cryptographically secure computer-on-a-chip or microprocessor. The secure element 104 can conduct secure operations and can include a trusted execution environment on a secure area of a processor.

The resource provider computer 106 can be a server computer or a mobile device operated by a resource provider. The resource provider computer 106 can be registered with the program smart contract 114 and the offline interaction smart contract 116. The resource provider computer 106 can provide resources to the user of the user device 102. The resource provider computer 106 can generate an interaction request message to request to receive a requested amount from the user device 102 for an interaction between the resource provider computer 106 and the user device 102 for one or more resources.

The secure element 120 can be similar to the secure element 104. The secure element 120 can include a cryptographically secure computer-on-a-chip or microprocessor. The secure element 120 can conduct secure operations and can include a trusted execution environment on a secure area of a processor. In some embodiments, the resource provider computer 106 may not include a secure element 120.

The service provider computer 108 can be a remote server computer. The service provider computer 108 can provide an offline amount to the user device 102 to be stored in the secure element 104 of the user device 102. For example, the user device 102 can request an offline amount from the service provider computer 108. In other situations, the service provider computer 108 can push an offline amount to the user device 102. The service provider computer 108 can also provide offline program tokens to the user device 102 for use in interactions that are eligible for the program.

The service provider computer 108 can be a processing network computer that may be configured to provide authorization services, and clearing and settlement services for payment transactions. A processing network computer may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular includes a Visa Integrated Payments (VIP) system which processes authorization requests and a Base II system which performs clearing and settlement services. Furthermore, the payment processing network may include a server computer and may use any suitable wired or wireless telecommunications network, including the Internet. In some embodiments, for authorization based transaction, the processing network computer may forward an authorization request received from a transport computer to the authorizing entity computer via a communication channel. The processing network computer may further forward an authorization response message received from the authorizing entity computer to the transport computer.

The program computer 110 can include a server computer. The program computer 110 can create (e.g., mint) program tokens. The program computer 110 can create program tokens on behalf of a central bank or other authority. The program computer 110 can issue program tokens to a user using the program smart contract 114 and the central authority smart contract 118 included in the blockchain network 112. The program computer 110 can convert central bank digital currency into program tokens.

As an example, the program can be a supplemental nutrition assistance program (SNAP). The program tokens can be SNAP tokens and can be spent by users on SNAP eligible resources, such as specific food products. The SNAP tokens may not be spent of resources that are not program eligible (e.g., furniture). In this example, the program computer 110 can be operated by an entity such as the USDA.

The blockchain network 112 can include a program smart contract 114, an offline interaction smart contract 116, and a central authority smart contract 118. The blockchain network 112 can maintain a record of interactions and balances. The blockchain network 112 can maintain and update smart contracts. The blockchain network 112 can also manage different types of values such as cryptocurrencies such as USDC and program tokens such as SNAP program tokens. Additions or reductions of such values on the blockchain(s) managed by the blockchain network 112 can take place using conventional technologies such as those used in Bitcoin and Ethereum, and other cryptocurrencies.

The program smart contract 114 can include a smart contract that relates to creation, conversion, and maintenance of program tokens for a program. The program smart contract 114 can create program tokens from a central bank digital currency (CBDC). The program computer 110 can create program tokens using the program smart contract 114 by calling an API method on the program smart contract 114. For example, the program computer 110 can call a “createProgramTokens” method on the program smart contract 114 and provide an amount of CBDC as input to the function. The program smart contract 114 can maintain a balance of CBDC, to which the received CBDC can be added. The program smart contract 114 can mint new program tokens equivalent to the amount to received CBDC. The program smart contract 114 can then provide the program tokens to the program computer 110.

The program smart contract 114 can maintain a list of registered resource providers that are authorized to receive program tokens. The list of registered resource providers can include a list of resource provider computer account address (e.g., blockchain network 112 based address).

The offline interaction smart contract 116 can include a smart contract that relates to allowing user devices to obtain offline amounts of CBDC, offline program tokens, etc. The offline interaction smart contract 116 can include an entry in the data of the contract called a variations entry that allow for several variations to affect the offline interaction smart contract 116. For example, the offline interaction smart contract 116 can include a variation that includes an address for the program smart contract 114. The variation can be that program tokens can be utilized in place of CBDC in certain circumstances. The offline interaction smart contract 116 can function as a registered resource provider for the program of the program smart contract 114. As such, the offline interaction smart contract 116 can convert program tokens to CBDC. For example, the offline interaction smart contract 116 can be registered with the program smart contract 114, thus allowing the offline interaction smart contract 116 to receive and process program tokens.

The central authority smart contract 118 can include a smart contract that is associated with creating and distributing CBDC. The central authority smart contract 118 can authorize program computers to convert CBDC to program tokens for programs. For example, the central authority smart contract 118 can authorize the program computer 110 to generate program tokens that are equivalent in value to the CBDC. In some embodiments, the central authority smart contract 118 can be created, managed, or updated by a central authority such as a central bank of a country.

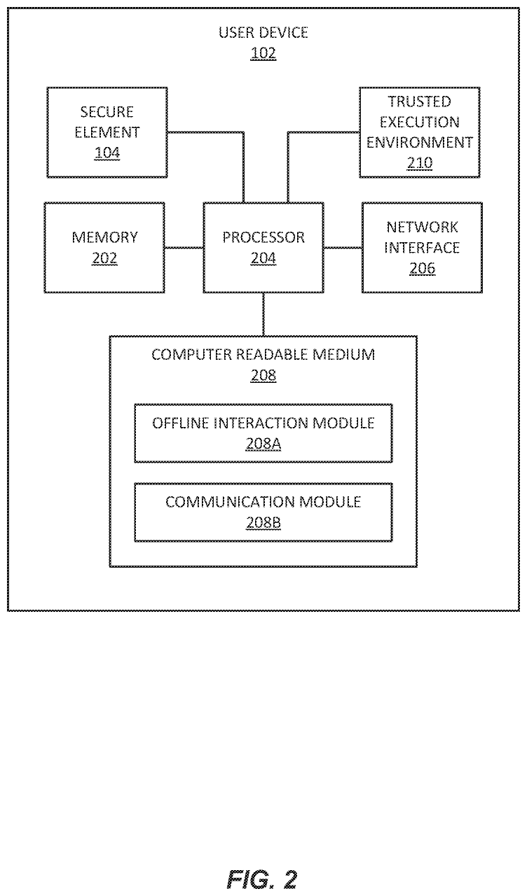

FIG. 2 shows a block diagram of a user device 102 according to embodiments. The exemplary user device 102 may comprise a processor 204. The processor 204 may be coupled to a memory 202, a network interface 206, the secure element 104, a computer readable medium 208, and a trusted execution environment 210. The computer readable medium 208 can include one or more modules. For example, the computer readable medium 208 can include an offline interaction module 208A and a communication module 208B.

The memory 202 can be used to store data and code. For example, the memory 202 can store cryptographic keys, amounts, etc. The memory 202 may be coupled to the processor 204 internally or externally (e.g., cloud based data storage), and may comprise any combination of volatile and/or non-volatile memory, such as RAM, DRAM, ROM, flash, or any other suitable memory device.

The computer readable medium 208 may comprise code, executable by the processor 204, for performing a method comprising: receiving, by a user device, an interaction request message for an interaction, the interaction request message comprising a program eligibility indicator, an amount, and a resource provider certificate from a resource provider computer; selecting, by a secure element on the user device, between an offline balance and an offline amount of program tokens stored in the secure element based on the program eligibility indicator, wherein the offline amount of program tokens is selected; deducting, by the secure element on the user device, the amount from the offline amount of program tokens; and completing, by the user device, the interaction with the resource provider computer.

The offline interaction module 208A may comprise code or software, executable by the processor 204, for processing offline interactions. The offline interaction module 208A, in conjunction with the processor 204, can receive interaction request messages comprising a requested amount for interactions involving the user device 102. The offline interaction module 208A, in conjunction with the processor 204 and the secure element 104, can determine whether or not the secure element 104 has sufficient offline funds (e.g., in an offline balance and/or in an offline amount of program tokens). The offline interaction module 208A, in conjunction with the processor 204 and the secure element 104, can deduct the requested amount from offline funds included in the secure element 104. The offline interaction module 208A, in conjunction with the processor 204 and the secure element 104, can generate an interaction response message that indicates that the interaction is accepted and processed by the secure element 104.

The communication module 208B can include may comprise code or software, executable by the processor 204, for communicating with other devices. The communication module 208B, in conjunction with the processor 204, can format communication messages such that other receiving devices can interpret the communication messages. The communication module 208B, in conjunction with the processor 204, can parse received messages according to formats such that the data included in the received messages can be interpreted by the user device 102.

The secure element 104 can include an element that is secure. The secure element 104 can include a cryptographically secure computer-on-a-chip or microprocessor. The secure element 104 can conduct cryptographic operations and may be embedded in a packaging with one or more physical security measures. In some embodiments, the secure element 104 can include a component that can perform a function securely. The secure element 104 may be a memory that securely stores data, such that its access is protected. The secure element 104 can partially or wholly include the trusted execution environment 210 on a secure area of a processor. An example of the secure element 104 is a universal integrated-circuit card (UICC). Another example of the secure element 104 is an embedded secure element, an embedded hardware component in a larger mechanical or electrical system. Another example of the secure element 104 is a hardware security module (HSM), which is a physical computing device that can safeguard and manage cryptographic keys for authentication and provide crypto-processing functions.

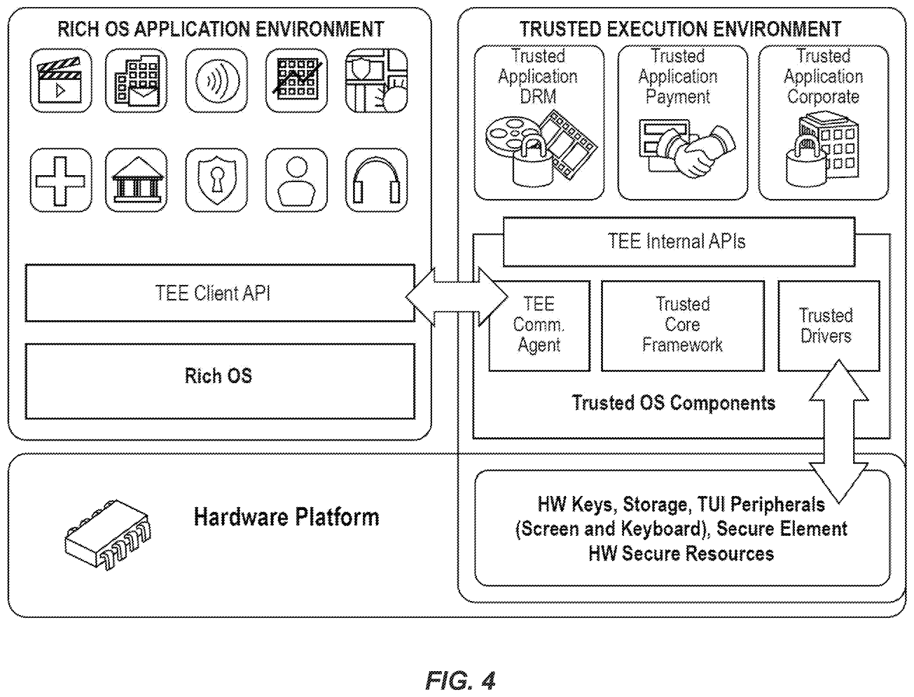

The trusted execution environment 210 can be included on the user device 102. The trusted execution environment 210 can be located within any suitable secure hardware element included in the user device 102. In some embodiments, the trusted execution environment 210 can be a secure software module in the user device 102. In some embodiments, the trusted execution environment 210 can be located partially within the secure element 104 and partially outside of the secure element 104, where each portion provides different capabilities. The trusted execution environment 210 is further described in reference to FIG. 4.

The network interface 206 may include an interface that can allow the user device 102 to communicate with external computers. The network interface 206 may enable the user device 102 to communicate data to and from another device (e.g., the resource provider computer 106, the service provider computer 108, the blockchain network 112, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

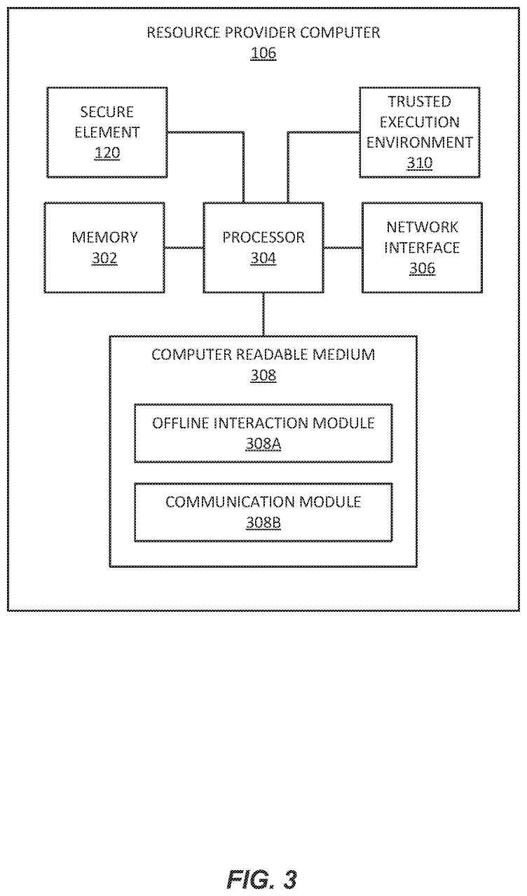

FIG. 3 shows a block diagram of a resource provider computer 106 according to embodiments. The exemplary resource provider computer 106 may comprise a processor 304. The processor 304 may be coupled to a memory 302, a network interface 306, the secure element 120, a computer readable medium 308, and a trusted execution environment 310. The computer readable medium 308 can comprise an offline interaction module 308A and a communication module 308B.

The memory 302 can be used to store data and code and may be similar to the memory 202 as described herein.

The computer readable medium 308 may comprise code, executable by the processor 304, for performing a method comprising: generating, by a resource provider computer, an interaction request message for an interaction, the interaction request message comprising a requested amount; transmitting, by the resource provider computer, the interaction request message to a user device, wherein a secure element on the user device selects between an offline balance and an offline amount of program tokens stored in the secure element, and wherein the secure element on the user device deducts the amount from the offline amount of program tokens and generates an interaction response message; receiving, by the resource provider computer, the interaction response message from the user device, wherein the interaction response message comprises an amount equal to the requested amount; and completing, by the resource provider computer, the interaction with the user device based on the amount.

The offline interaction module 308A may comprise code or software, executable by the processor 304, for processing offline interactions. The offline interaction module 308A, in conjunction with the processor 304, can generate interaction request messages comprising a requested amount for an interaction between the resource provider computer 106 and the user device 102. The offline interaction module 308A, in conjunction with the processor 304, can generate interaction request messages comprising the requested amount and a program eligibility indicator and a resource provider certificate. The offline interaction module 308A, in conjunction with the processor 304, can receive an interaction response message from the user device 102 after the user device 102 accepts and processes the interaction. The interaction response message can include an amount equal to the requested amount, the user device certificate, a user device secure element certificate, the resource provider certificate, and a digital signature formed from a user device secure element private key. The offline interaction module 308A, in conjunction with the processor 304, can process the interaction response message and can update an offline balance included in the secure element 120 based on the amount.

The communication module 308B can include may comprise code or software, executable by the processor 304, for communicating with other devices. The communication module 308B, in conjunction with the processor 304, can format communication messages such that other receiving devices can interpret the communication messages. The communication module 308B, in conjunction with the processor 304, can parse received messages according to formats such that the data included in the received messages can be interpreted by the resource provider computer 106.

The secure element 120, the network interface 306, and the trusted execution environment 310 may be similar to the secure element 104, the network interface 206, and the trusted execution environment 310, respectively, and will not be repeated here.

A trusted execution environment can be a hardware-assisted execution environment within a system with its own resources (e.g., memory, registers, peripherals, and its own software stack, such as OS, applications etc.). The resources of the trusted execution environment as well as the processes running within the trusted execution environment cannot be accessed by the rest of the system directly.

FIG. 4 shows an illustration of an overview of a user device that hosts a trusted execution environment. The resources of the system are split into two execution environments via hardware means: a rich operating system execution environment (REE) and a trusted execution environment (TEE). The trusted execution environment has its own dedicated memory, registers etc. along with its own trusted operating system. On top of the trusted operating system, third-party trusted applications can be built by making use of trusted execution environment internal APIs. Similarly, a client application can be built on top of the rich operating system. Applications running in the trusted execution environment can access the resources of the rich operating system execution environment, but application running in the rich operating system execution environment cannot access the resources of the trusted execution environment. A client application residing in the rich operating system execution environment can communicate with a trusted application only via the trusted execution environment client APIs if the client application requests the services of the trusted application.

There can be different variations of trusted execution environments depending on the platform upon which they run and/or the hardware used to achieve the isolation in the system. Since various embodiments can be performed on mobile devices, trusted execution environments that run on mobile devices are provided as an example. However, it is noted that embodiments are not limited thereto. For example, the trusted execution environment can use a TrustZone architecture (by Arm). The TrustZone architecture achieves the isolation in the system by augmenting computation cores with a mode that allows them to operate only for the trusted execution environment. A physical core is split into two virtual cores with TrustZone: one virtual core operates only for trusted execution environment and the other operates for the rest of the system. To switch from one environment to another, system calls can be used. Applications running within a trusted execution environment may be further isolated from each other by the OS running in trusted execution environment.

Before registering a device which uses trusted execution environment functionalities in the offline interaction system protocol, an original equipment manufacturer (OEM) can attest that the trusted execution environment within a device is set up correctly. Then, embodiments can ensure that the trusted execution environment is provisioned with the right applications. Finally, embodiments can register the instance of a trusted application running in a device if the attestation and the provisioning verifications are successful.

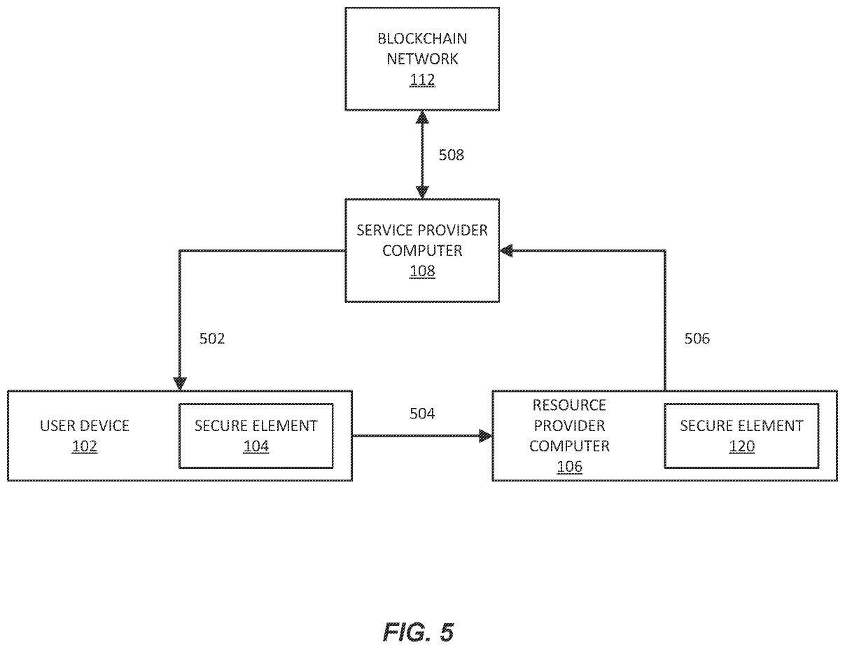

FIG. 5 shows a flow diagram of an offline interaction method according to embodiments. The method illustrated in FIG. 5 includes an overview of the offline interaction process, where the user device 102 obtains an offline balance from the service provider computer 108 and interacts offline with the resource provider computer 106. The resource provider computer 106 can then add the offline balance obtained from the user device 102 to an online balance maintained by the service provider computer 108 in conjunction with the blockchain network 112.

At step 502, the user device 102 can initially deposit funds into the secure element when the user device 102 is online, such that the user device 102 can later be able to perform offline interactions. For example, the user device 102 can request the service provider computer 108 to deposit (e.g., deposit to the secure element 104) an amount of x funds from an online amount stored at the service provider computer 108 and associated with the user device 102 into an offline amount stored in the secure element or a trusted application. The service provider computer 108 responds with a signature showing that x was deducted from user device 102 online amount. The secure element of the user device 102 verifies the signature with the server's public verification key and adds x to the offline amount stored in the secure element of the user device 102.

At step 504, an offline interaction can be initiated by the resource provider computer 106 (e.g., a receiver device), which sends an interaction request message to the user device 102. The interaction request message can include the resource provider computer's 106 certificate and a requested amount. Upon receiving the interaction request message, the user device 102 invokes the secure element 104 to securely deduct the interaction amount from the secure elements offline amount and create a signed interaction response message including the interaction amount and the certificates of both devices (e.g., the sender certificate and the receiver certificate). The user device 102 sends the interaction response message to the resource provider computer 106. After receiving the interaction response message, the resource provider computer 106 verifies the user device's 102 signature and certificate. The resource provider computer 106 can then ensure that the interaction response message contains its own certificate (e.g., the receiver certificate). If each verification is successful, then the resource provider computer 106 accepts the interaction and can store the interaction response message. The secure element 120 of the resource provider computer 106 can update an offline balance maintained by the secure element 120 of the resource provider computer 106 (e.g., collect) based on the amount of the interaction.

At step 506, the resource provider computer 106 can perform a claim protocol by adding the amount of the interaction as indicated in the interaction response message that was received offline from the user device 102 to an online amount associated with the resource provider computer 106 and stored at the service provider computer 108. During the claim protocol, the resource provider computer 106 sends the interaction response message to the service provider computer 108. The service provider computer 108 verifies the validity of the interaction response message and checks if the interaction response message was not previously marked as spent using an interaction log stored by the service provider computer 108. If all verifications succeed, then the service provider computer 108 can add the amount indicated in the interaction response message to the resource provider computer's 106 online amount and adds the interaction response message to the interaction log.

At step 508, the service provider computer 108 can communicate any changes to the online amounts maintained by the service provider computer 108 with the blockchain network 112 via the offline interaction smart contract 116 (not shown).

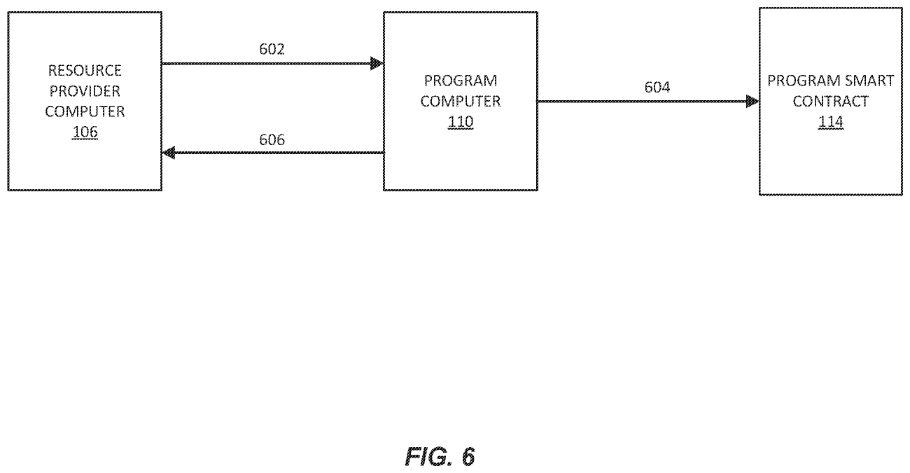

FIG. 6 shows a flow diagram of a program registration method according to embodiments. FIG. 6 illustrates a resource provider computer 106 registering to participate in a program with the program computer 110. The program can be, for example, a supplemental nutrition assistance program provided by a governmental organization, a rewards program, a housing assistance program, etc.

At step 602, the resource provider computer 106 can generate and transmit a registration request message to the program computer 110 to register the resource provider computer 106 in the program. The registration request message can include details regarding the resource provider and/or the resource provider computer 106. For example, the registration request message can include a resource provider identifier, a resource provider computer identifier, a resource provider computer certificate, a list of resources provided by the resource provider, a government issued identifier, etc.

The program computer 110 can receive the registration request message and determine whether or not to register the resource provider computer 106 into the program. For example, the program computer 110 can evaluate the data in the registration request message to determine if the resource provider computer 106 is eligible based on one or more criteria to participate in the program.

At step 604, upon determining to register the resource provider computer 106 into the program, the program computer 110 can provide a resource provider account address to a program smart contract 114. The resource provider account address can be received from the resource provider computer 106 in the registration request message or created by the program computer 110 on behalf of the resource provider computer 106.

The program smart contract 114 can be a smart contract maintained by a blockchain network. The program smart contract 114 can include a plurality of resource provider account addresses from a plurality of resource provider computers. The program computer 110 can call an exposed API method to add the resource provider account address to the program smart contract 114.

At step 606, after adding the resource provider account address to the program smart contract 114, the program computer 110 can generate an authorized resource provider certificate and provide the authorized resource provider certificate to the resource provider computer 106. The authorized resource provider certificate can indicate that the resource provider computer 106 is authorized to receive program tokens during interactions. The inclusion of the resource provider account address into the program smart contact 114 can act as proof that the resource provider computer 106 can participate in the program. For example, the resource provider computer 106 can offer resources (e.g., food products) that are eligible to be purchased with program tokens (e.g., supplemental nutrition program tokens).

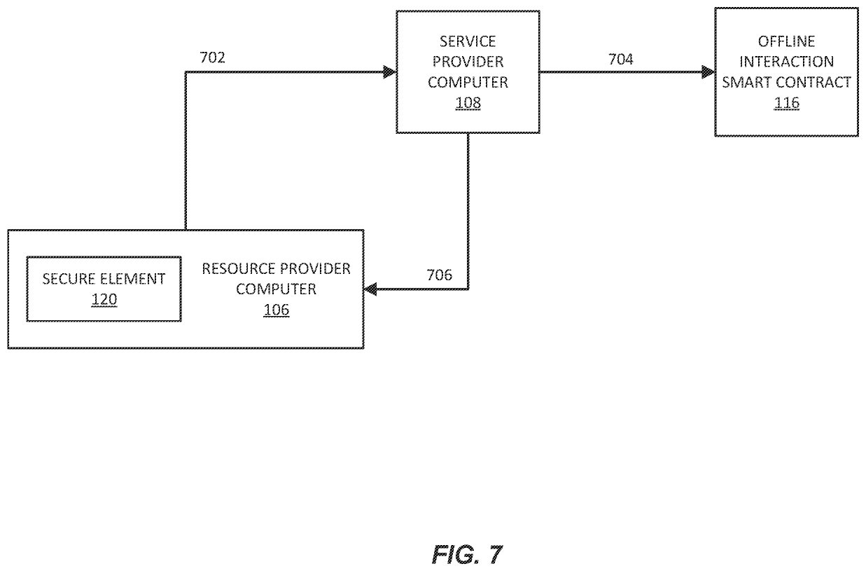

FIG. 7 shows a flow diagram of an offline interaction system registration method according to embodiments. FIG. 7 illustrates a resource provider computer 106 registering with a service provider computer 108 into an offline interaction system that allows the resource provider computer 106 to perform offline interactions.

At step 702, the resource provider computer 106 can generate an enrollment request message that includes a verification key and a resource provider computer certificate. The resource provider computer 106 can provide the enrollment request message to the service provider computer 108.

The service provider computer 108 can determine whether or not to enroll the resource provider computer 106 into the offline interaction system. The service provider computer 108 can make the enrollment determination based on any number of criteria. For example, one criteria can be that the resource provider computer certificate is valid. Other criteria can be that the resource provider computer certificate is not included in a negative list.

At step 704, upon determining to enroll the resource provider computer 106 into the offline interaction system, the service provider computer 108 can provide the verification key to the offline interaction smart contract 116 to register the resource provider computer's verification key into the offline interaction smart contract 116. The service provider computer 108 can call an exposed API method on the offline interaction smart contract 116 to add the resource provider computer's verification key to a list of enrolled verification keys.

At step 706, after adding the resource provider computer's verification key to the offline interaction smart contract 116, the service provider computer 108 can then create and issue a resource provider computer offline certificate to the resource provider computer 106.

The resource provider computer 106 can include a secure element, in some embodiments, and can store the verification key, the resource provider computer certificate, and the resource provider computer offline certificate in the secure element 120.

In some embodiments, any user device can enroll in the offline interaction system with the service provider computer 108 in a similar method to the method described in reference to FIG. 7.

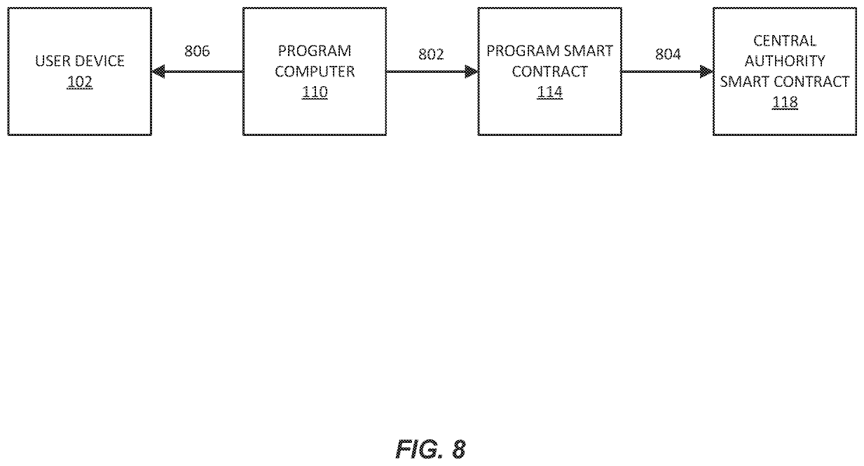

FIG. 8 shows a flow diagram of a program token creation method according to embodiments. FIG. 8 illustrates a program computer 110 (e.g., operated by an authorized program token minter such as the United States Department of Agriculture) that issues program tokens to a user of a user device 102. The user can be enrolled in the program (e.g., a SNAP program) by a governmental agency (e.g., the USDA).

The program computer 110 can create (e.g., mint) program tokens for a plurality of users. The program computer 110 can create a predetermined number of program tokens for each user at predetermined times (e.g., 500 per month). The program computer 110 can mint new program tokens at any cadence or schedule.

Table 1, below, illustrates the minting of program tokens. Minting can be the process of creating new tokens through smart contracts. The entry 1 row indicates that the user device can start with 1,000 CBDC and 0 SNAP program tokens. The program computer 110 can start with 10,000 CBDC, while the offline interaction smart contract 116 and the program smart contract 114 begin with 0 CBDC. There are no entries of program tokens yet.

At step 802, the program computer 110 can indicate to the program smart contract 114, which is stored on a blockchain network, that a number of program tokens are to be created for a particular user device. The program computer 110 can deduct the amount of program tokens to be created from the CBDC balance maintained by the program computer 110 and transfer the amount to the program smart contract 114. For example, the program computer 110 may already store the address of the location on the blockchain at which the program smart contract 114 is stored. The program computer 110 can utilize the address to find the program smart contract 114 and can then call a method (e.g., function) in the program smart contract 114. The method in the program smart contract 114 can expose functionality of the code included in the program smart contract 114 The method can process requests to create program tokens using input CBDC (e.g., input into the function).

For example, the program computer 110 starts with 10,000 CBDC and indicates to the program smart contract 114 to create 1,000 program tokens. The program computer 110 deducts 1,000 CBDC from the program computer's CBDC balance. The program smart contract 114 can receive the 1,000 CBDC and increase the amount of CBDC maintained by the program smart contract 114. The program smart contract 114 can include an amount of CBDC currently provided to enrolled users as program tokens.

At step 804, the program computer 110 can mint program tokens. However, to keep the total supply of CBDC constant, the program computer 110 can provide an equivalent amount of CBDC to the program smart contract 114. The CBDC in the program smart contract 114 will be locked (e.g., held in the program smart contract 114) until the program tokens are utilized, at which point, the CBDC can be provided to the relevant entity that claims that the program tokens were utilized. In this way, the program computer 110 is not creating new CBDC or changing the amount of currency in the system.

The created program tokens are assigned to a digital address stored in the program smart contract 114. The digital address can be stored in a list in the program smart contract 114. The digital address can be a blockchain address that corresponds to the user device 102. In some embodiments, the digital address can be a user device account identifier such as a public key associated with the user device 102.

At step 806, the program computer 110 can generate and transmit a program token creation notification to the user device 102. The program token creation notification can notify the user device 102 of the newly minted and available program tokens.

TABLE 1
Minting program tokens example

| | | | | | Offline | | Program | |
|---|---|---|---|---|---|---|---|---|
| | | | Program | | interaction | | smart | |
| | User device | | computer | | smart contract | | contract | |
| | CBDC | SNAP | CBDC | SNAP | CBDC | SNAP | CBDC | SNAP |
| Entry | 1,000 | | 10,000 | | 0 | | 0 | |
| 1 | | | | | | | | |
| Entry | 1,000 | 1,000 | 9,000 | | 0 | | 1,000 | |
| 2 | | | | | | | | |

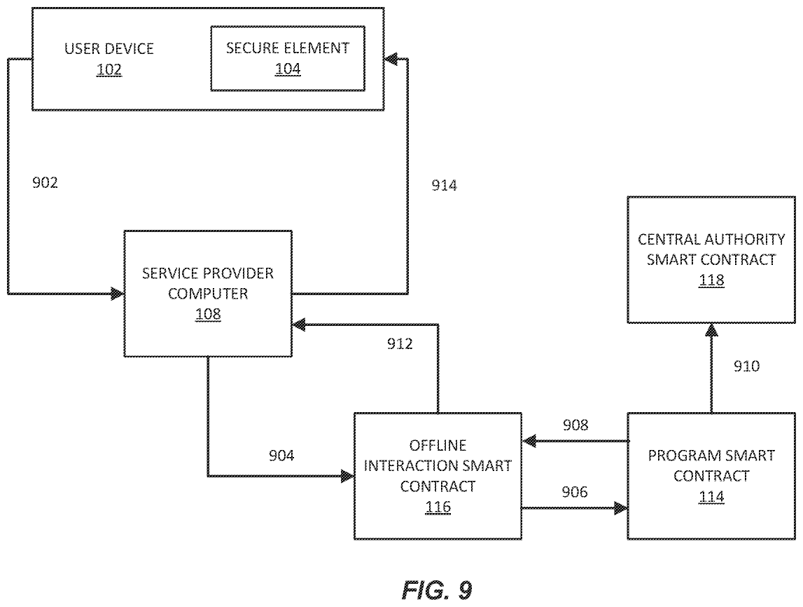

FIG. 9 shows a flow diagram of transferring program tokens to an offline balance according to embodiments. FIG. 9 illustrates a user device 102 requesting to transfer an online balance of program tokens maintained by the service provider computer 108 to an offline balance maintained by the secure element 104 installed on the user device 102. In some embodiments, the resource provider computer 106 can perform the method illustrated in FIG. 9 to deposit funds to the secure element 120 on the resource provider computer 106.

At step 902, the user device 102 can generate a deposit request message requesting the service provider computer 108 to deposit an amount of program tokens to the user device's 102 secure element. The deposit request message can include an amount (e.g., 200) of digital tokens that will be stored in the secure element, and a type of digital tokens to provide (e.g., program tokens, CBDC, etc.). The deposit request message can also include a user device address or a secure element address. The user device 102 can provide the deposit request message to the service provider computer 108.

At step 904, after receiving the deposit request message from the user device 102, the service provider computer 108 can provide the deposit request message to the offline interaction smart contract 116 to initiate transfer of the amount to the offline balance of the user. The service provider computer 108 can store an address at which the offline interaction smart contract 116 is located at in the blockchain network. The service provider computer 108 can utilize the address to identify the offline interaction smart contract 116 and to communicate with the offline interaction smart contract 116 via API calls. For example, the service provider computer 108 can call an exposed method in the offline interaction smart contract 116 to provide the deposit request message to the offline interaction smart contract 116. The method can accept the deposit request message as input. The method can process the deposit request message and may initiate transfer of the amount to the offline balance of the user.

For example, the service provider computer 108 can provide the deposit request message of Deposit (200, SNAP) to the offline interaction smart contract 116. The deposit request message of Deposit (200, SNAP) can indicate to provide 200 SNAP program tokens to the secure element 104 from the program smart contract 114.

At step 906, the offline interaction smart contract 116, acting as a registered entity with the program smart contract 114, can request CBDC and a deposit proof that indicates a transfer of program tokens from the program smart contract 114 in order to initiate the transfer the 200 offline program tokens to the secure element 104. The offline interaction smart contract 116 can request 200 worth of CBDC and a deposit proof indicating 200 worth of program tokens (e.g., SNAP program tokens), which are to be provided to the secure element 104. The 200 worth of CBDC becomes locked into the offline interaction smart contract 116 until later redeemed or otherwise used. The 200 CBDC comes from the locked CBDC balance maintained by the program smart contract 114. This is depicted in Table 2 below, which shows in Entry 2, “200” in the CBDC column for the offline interaction smart contract. The offline interaction smart contract 116 can store an address of the program smart contract 114 that indicates the location at which the program smart contract 114 is stored on the blockchain. The offline interaction smart contract 116 can notify the program smart contact 114 of the change by calling an exposed method on the program smart contract 114.

After receiving the request for CBDC and the deposit proof, the program smart contract 114 can determine if the user device 102 or the secure element 104 is associated with an account or address stored in a list of addresses included in the program smart contract 114 using an address included in the deposit request message. If the user device 102 or the secure element 104 is associated with an amount of program tokens maintained by the program smart contract 114, then the program smart contract 114 can verify that the user has sufficient program tokens to transfer to offline program tokens. If the user does not have sufficient program tokens (e.g., does not have 200 online program tokens), then the program smart contract 114 can deny the transfer. As depicted in Table 2, in entry 1, the user device 102 is associated with 1000 program tokens (e.g., online SNAP program tokens). As such, the user device 102 has sufficient online program tokens to cover the deposit request.

If the user has sufficient program tokens, the program smart contract 114 can deduct the requested amount of program tokens (e.g., 200 program tokens) from the user's online amount of program tokens (e.g., 1000−200=800) and recorded in a deposit proof. The program smart contract 114 can also decrease the amount of CBDC locked into the program smart contract 114, which will be provided to the offline interaction smart contract 116 and locked therein. For example, with reference to Table 2, the “200” CBDC was obtained by the offline interaction smart contract 116 from the program smart contract 114 as shown by the decrease in CBDC from Entries 1 to 2 from 1000 CBDC to 800 CBDC. As such, the overall amount of funds has remained constant (e.g., no funds have been created or destroyed). Further, the offline interaction smart contract 116 maintains a balance of 200 CBDC, which indicates that there is an equivalent of 200 CBDC stored in offline secure elements (e.g., 200 CBDC worth of program tokens stored in the secure element 104).

At step 908, the program smart contract 114 can transmit the deposit proof and the CBDC to the offline interaction smart contract 116. For example, the program smart contract 114 can transmit the deposit proof that indicates 200 worth of offline program tokens are meant for the secure element 104, and the 200 CBDC to the offline interaction smart contract 116. The 200 CBDC can become locked into the offline interaction smart contract 116. Doing so can indicate that there is an equivalent worth of 200 CBDC stored in offline secure elements as offline program tokens (e.g., store in the secure element 104 as 200 program tokens such as SNAP program tokens).

At step 910, in some embodiments, the program smart contract 114 may notify the central authority smart contract 118 of the transfer of online program tokens to offline program tokens.

The deposit proof be a blockchain inclusion proof that is able convince the service provider computer 108 of any event on the blockchain. As such, these deposit proofs need to convince the service provider computer 108 that the deposit transaction was executed correctly. There can be different types of blockchain inclusion proofs that may need to interact with the smart contract(s) and the user device. For example, blockchain inclusion proofs differ based on the underlying architecture of the ledger protocol where the smart contract is hosted. These distributed ledgers can be broadly classified into two categories: 1) Nakamoto consensus and 2) Byzantine fault tolerant (BFT) consensus.

As an example, to generate an inclusion proof, nodes in X participate in a one-time setup protocol for threshold signing-verification key. One such example is a threshold signature where the verification key (vk) is a public parameter and the signing key (sk) is secret that is shared among all nodes in X. Then after the setup phase, each node in X will receive their share of the secret key. The secure element on the user device can be initialized with the verification key vk. Once the key is established, the inclusion proof (e.g., the deposit proof) for each interaction can be a threshold signature on the block that includes the interaction. Hence, for these blockchains, the secure element on the user device can validate the inclusion of the deposit message (e.g., the deposit proof) by validating a single signature. Also, the size of such inclusion proof is at most the size of the block that includes the transaction, which can further be reduced by using techniques such as Merkle trees.

In some embodiments, a threshold signature may not be necessary, and embodiments can use standard signatures where the inclusion proof will be a list of signatures of a subset of nodes in X or a cryptographic multi-signature from a subset of nodes. The advantage of using standard signature or multi-signature is that their setup phase can be realized without using a trusted party. The downside of using them is the increase in the proof size.

In protocols where the set of signers changes rapidly, every block or a group of blocks might be signed by a completely different set of signers. As a result, in such situations the above-mentioned approach of initializing the secure element on the user device with the one-time public verification key may not work.

One approach to generate inclusion proofs for these ledgers is as follows. For any such ledger, the secure element on the user device is initialized with the identities of the first set of nodes. The secure element on the user device can trust this set of nodes. Then, in every subsequent block where the set X gets updated, the existing set authorizes the new set with a list of signatures or multi-signatures.

In such a setting, the inclusion proof is the entire chain of authorization starting from the genesis block. The size of such inclusion proof is large. This technical problem can be addressed by a checkpointing technique. Thus, each node will only need to download the authorization chain from the latest checkpoint.

At step 912, offline interaction smart contract 116 can transmit the deposit proof to the service provider computer 108. For example, the service provider computer 108 can utilize an API call on the offline interaction smart contract 116 that accepts the deposit request message (e.g., at step 904) and returns (e.g., outputs) the deposit proof.

At step 914, after obtaining the deposit proof from the offline interaction smart contract 116, the service provider computer 108 can transmit the deposit proof to the user device 102.

After receiving the deposit proof, the user device 102 can provide the deposit proof to the secure element 104. The secure element 104 can then evaluate the deposit proof to determine whether or not the proof is valid. If the deposit proof is valid, then the secure element 104 can then increase the offline amount of program tokens based on the amount indicated in the deposit request message.

TABLE 2
Transfer amount to offline balance example

| | | | | | Offline | | Program | |
|---|---|---|---|---|---|---|---|---|
| | | | Program | | interaction | | smart | |
| | User device | | computer | | smart contract | | contract | |
| | CBDC | SNAP | CBDC | SNAP | CBDC | SNAP | CBDC | SNAP |
| Entry | 1,000 | 1,000 | 9,000 | | | | 1,000 | |
| 1 | | | | | | | | |
| Entry | 1,000 | 800 | 9,000 | | 200 | | 800 | |
| 2 | | (+200 | | | | | | |
| | | offline | | | | | | |
| | | on | | | | | | |
| | | TEE) | | | | | | |

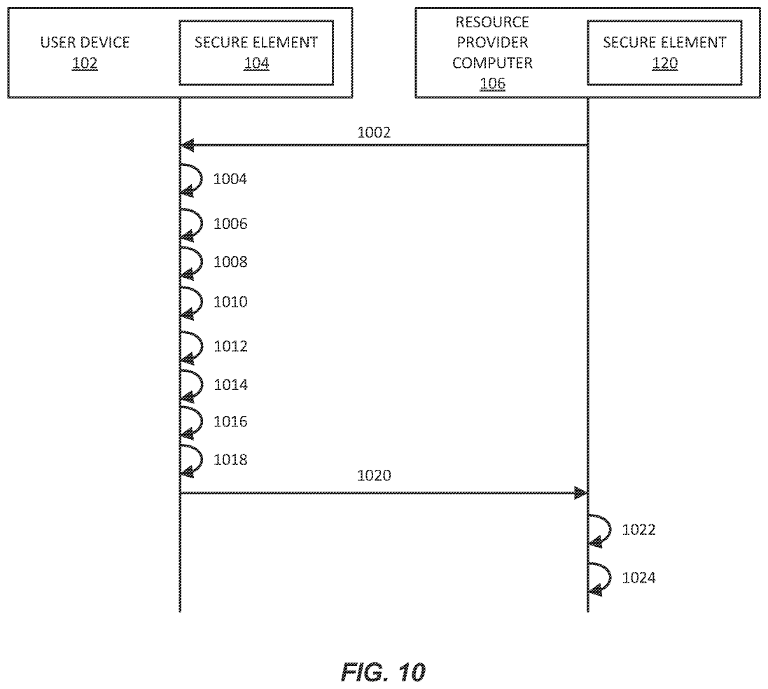

FIG. 10 shows a flow diagram of an offline interaction method using program tokens according to embodiments. FIG. 10 illustrates a user device 102 utilizing program tokens during an interaction with a resource provider computer 106.

At step 1002, the resource provider computer 106 can provide an interaction request message to the user device 102 after the user selects resources to obtain from the resource provider. The interaction request message can include a requested amount. The requested amount can be a total amount based on the resources involved in the interaction. In some embodiments, the interaction request message can include a resource provider computer certificate of the resource provider computer 106. In other embodiments, the interaction request message can include a program eligibility indicator that indicates whether or not the interaction qualifies for the program offered by the program computer 110. For example, the program eligibility indicator can be true or false based on the resources involved in the interaction.

At step 1004, after receiving the interaction request message from the resource provider computer 106, the user device 102 can provide the interaction request message to the secure element 104 in the user device 102.

At step 1006, after receiving the interaction request message, the secure element can verify the resource provider computer certificate if included in interaction request message. For example, the resource provider computer certificate can be issued and/or signed by the service provider computer. The user device 102 can store the service provider computer public key that corresponds to the service provider computer private key that is used to sign certificates. The user device 102 can verify the resource provider computer certificate that is signed by the service provider computer private key using the service provider public key.

In some embodiments, at step 1008, the secure element 104 of the user device 102 can evaluate the program eligibility indicator if included. The secure element 104 can determine if the interaction is eligible for the program based on the program eligibility indicator. For example, the program eligibility indicator can be a Boolean value. If the program eligibility indicator is true, then the interaction is eligible for the program. If the program eligibility indicator is false, then the interaction is not eligible for the program. If the interaction is not eligible for the program, then the secure element 104 can proceed to process the interaction using the offline balance (e.g., the offline CBDC balance) at step 1010 without the evaluation of the offline program tokens. If the interaction is eligible for the program, then the secure element 104 can proceed to step 1010.

At step 1010, the secure element 104 can determine if there is a sufficient amount of offline program tokens in the secure element 104 and/or a sufficient amount in the offline balance to satisfy the requested amount included in the interaction request message. For example, the secure element 104 can compare the requested amount (e.g., $100) to the amount of offline program tokens (e.g., 200). The secure element 104 can determine that there is a sufficient amount of offline program tokens if the amount of program tokens is equal to or greater than (e.g., exceeds) the requested amount. Similarly, the secure element 104 can compare the requested amount (e.g., $100) to the amount in the offline balance (e.g., $100). The secure element 104 can determine that there is a sufficient amount in the offline balance if the amount in the offline balance is equal to or greater than the requested amount.

If there is not a sufficient amount of the offline program tokens and the offline balance in combination to satisfy the requested amount, then the secure element 104 can decline in the interaction. In such a case, the secure element 104 can create and provide an interaction response message that indicates that the interaction is declined to the user device 102. The interaction response message can include a reason why the interaction is declined, for example, a lack of funds.

If there is a sufficient amount of the offline program tokens to satisfy the requested amount and there is a sufficient amount of the offline balance to satisfy the requested amount, then the secure element can proceed to step 1012 to request the user of the user device 102 to select between the two sources.

If there is not a sufficient amount of the offline program tokens to satisfy the requested amount and there is not a sufficient amount of the offline balance to satisfy the requested amount, but there is a sufficient amount of the offline program tokens and the offline balance in combination (e.g., added together) to satisfy the requested amount, then the secure element 104 can process a mixed source interaction. In some embodiments, the secure element 104 can include rules to first apply the offline program tokens to cover the requested amount and then apply the offline balance to cover the remaining portion of the requested amount. In other embodiments, the secure element 104 can prompt the user device 102 to prompt the user to select between which of the offline balance and the offline amount of program tokens to utilize to cover the requested amount first (e.g., a main funding source).

At step 1012, after evaluating the amount of the offline program tokens and the amount of the offline balance in relation to the requested amount, the secure element 104 of the user device 102 can prompt the user device 102 to prompt the user to select between an offline balance and an offline amount of program tokens stored in the secure element 104. The user device 102 can utilize an output device (e.g., a screen, speakers, etc.) to prompt the user of the user device 102 to select between the offline balance and the offline amount of program tokens stored in the secure element 104. The selection by the user also results in a corresponding selection by the secure element 104.

The user of the user device 102 can input a selection. The selection can be a selection of the offline balance or a selection of the offline amount of program tokens. The selection can be obtained by the user device 102 using an input device (e.g., a screen, buttons, etc.) and provided to the secure element 104.

The selection can be a selected source of funds to apply to the interaction's requested amount.

At step 1014, after receiving the selection between the offline balance and the offline amount of program tokens, the secure element 104 can perform the offline interaction using the selected source. As an example, the selected source can be a selection to utilize the offline amount of program tokens. The secure element 104 can deduct the requested amount from the offline amount of program tokens maintained by the secure element 104.

At step 1016, the user device 102 in conjunction with the secure element 104 can generate an interaction response message that indicates that the interaction is accepted by the user device 102 and was properly processed by the secure element 104. The interaction response message can include device certificates of the devices involved in the interaction. For example, the interaction response message can include a user device certificate, a user device secure element certificate, the resource provider computer certificate, etc. In some embodiments, the interaction response message can also include a counter value (j) that can be incremented for each interaction.

For example, the user device 102 can set the following values in the interaction response message P:
P.amount←x;
P.senderCert←T.cert;
P.receiverCert←receiverCert;
P.index←T.j;

At step 1018, after the user device 102 generates the interaction response message, the secure element 104 in the user device 102 can sign the interaction response message using a secure element private key. The secure element 104 can sign the interaction response message using a secure element private key associated with a secure element public key in a secure element certificate. The secure element 104 can sign the interaction response message by performing: Output P, where P.sig←Sign ([P.amount, P.senderCert, P.receiverCert, P.index], T.sk).

At step 1020, after generating the interaction response message, the user device 102 can provide the interaction response message to the resource provider computer 106.

At step 1022, after receiving the interaction response message from the user device 102, the resource provider computer 106 can verify the interaction response message. For example, the resource provider computer 106 can verify that the received resource provider computer certificate is the same as the actual resource provider computer certificate that was previously provided to the user device 102 (e.g., determines that the user device 102 did not tamper with the resource provider computer certificate). The resource provider computer 106 can verify the received user device certificate, for example, with a service provider computer public key. Further, the resource provider computer 106 can verify the signature of the interaction response message using the user device secure element public key of the user device secure element certificate (e.g., corresponding to the user device secure element private key used to create the signature).

At step 1024, the resource provider computer 106 can collect the amount indicated by the interaction request message into the secure element 120 of the resource provider computer 106. The resource provider computer secure element 120 can increase an offline CBDC balance maintained by the resource provider computer secure element 120 by the requested amount.

Table 3, below, illustrates the amounts of CBDC and program tokens of both the user and the resource provider. The first entry can occur before the interaction, while the second entry can occur after the interaction.

TABLE 3
Offline interaction example

| | User device | | Resource provider | |
|---|---|---|---|---|
| | CBDC | SNAP | CBDC | SNAP |
| Entry 1 | 1,000 | 800 | 1,000(+100 | |
| | | (+200 offline on TEE) | offline on TEE) | |
| Entry 2 | 1,000 | 800 | 1,000(+200 | |
| | | (+100 offline on TEE) | offline on TEE) | |

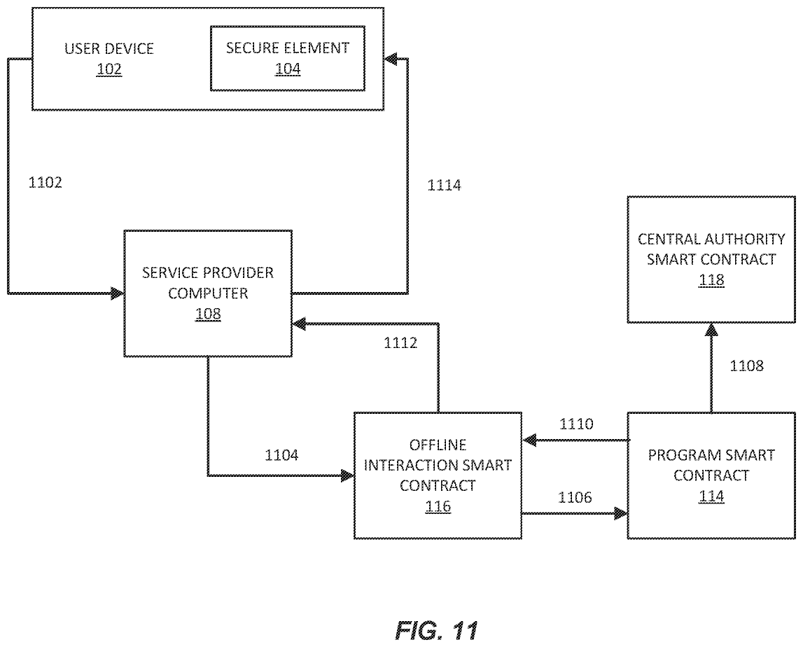

FIG. 11 shows a flow diagram of transferring program tokens on a secure element to an online balance according to embodiments. FIG. 11 illustrates a user device 102 requesting to transfer an offline balance maintained by a secure element installed on the user device 102 to an online balance of program tokens maintained by the service provider computer 108.

Table 4, below, illustrates amount balances. The first entry can occur before the withdraw that transfers the user's offline program tokens to an online program token account. The second entry can occur after the transfer.

The user device 102 can generate a withdraw request message that requests for the service provider computer 108 to withdraw an amount from the user device secure element 104 to the service provider computer 108. The secure element 104 (which may contain, for example, 100 SNAP program tokens) on the user device 102 can validate the offline program token balance, create a signature on the amount and an index i, which can be included in the withdraw request message. The amount of program tokens (e.g., 100 program tokens) can be deducted from the user's offline program token amount maintained by the secure element (e.g., 100−100=0).

At step 1102, The user device 102 can provide the withdraw request message to the service provider computer 108. The withdraw request can also include a user device address or a secure element address.

After receiving the withdraw request message, the service provider computer 108 can communicate with the offline interaction smart contract 116 to increase the user's online program token balance by the amount (e.g., 100 program tokens).

For example, at step 1104, the service provider computer 108 can provide the withdraw request message to the offline interaction smart contract 116. The offline interaction smart contract 116 can check for variation validity (e.g., that the program tokens are actual SNAP tokens and that the offline interaction smart contract 116 accepts SNAP tokens) and check for the validity of the signature and the index i. The offline interaction smart contract 116 can also increment the value for the offline balance index i (e.g., increment a transaction counter).

The offline interaction smart contract 116 can decrease the amount of locked CBDC maintained by the offline interaction smart contract 116 by the amount of received program tokens (e.g., 200−100=100). The CBDC maintained by the offline interaction smart contract 116 can indicate the amount of offline funds that exists (e.g., $100 CBDC worth, which can be held by the resource provider computer 106 after the transaction depicted in FIG. 10, above).

At step 1106, the offline interaction smart contract 116 can then communicate with the program smart contract 114 to add the program tokens the user's online program token account from the offline program tokens. As such, the offline interaction smart contract 116 can provide the offline program tokens and an equivalent amount of CBDC to the program smart contract 114. The offline interaction smart contract 116 can also provide the user device address or the secure element address to the program smart contract 114.

After receiving the offline program tokens (e.g., 100 program tokens) and the CBDC (e.g., $100) from the offline interaction smart contract 116, the program smart contract 114 can add the 100 program tokens to an online program token balance in an account associated with the user device address or the secure element address. The program smart contract 114 can also add the received CBDC to a locked amount of CBDC maintained by the program smart contract 114 (e.g., add 100 to the previously maintained 800). The total amount of CBDC locked into the program smart contract 114 represents how many program tokens are in existence (e.g., 900).

For example, as illustrated in Table 4, the user's program token online balance (e.g., online Snap program token balance) can be increased by 100 from 800 to 900. Doing so transfers the program tokens from offline funds to online funds.

In some embodiments, the program smart contract 114 can generate a withdrawal proof. The withdrawal proof can be a proof that the users online program token balance has been updated on the blockchain network. The withdrawal proof can be similar to the deposit proof.

At step 1108, in some embodiments, the program smart contract 114 can notify the central authority smart contract 118 of the changes.

At step 1110, the program smart contract 114 can indicate to the offline interaction smart contract 116 whether or not the transfer was successful. The program smart contract 114 can provide the withdrawal proof to the offline interaction smart contract 116.

At step 1112, the offline interaction smart contract 116 can indicate to the service provider computer 108 whether or not the transfer was successful. The offline interaction smart contract can provide the withdrawal proof to the service provider computer 108.

At step 1114, the service provider computer 108 can indicate to the user device 102 whether or not the transfer was successful. The service provider computer 108 can provide the withdrawal proof to the user device 102.

TABLE 4
Transfer amount to online balance example

| | | | | | Offline | | Program | |
|---|---|---|---|---|---|---|---|---|
| | | | Program | | interaction | | smart | |
| | User device | | computer | | smart contract | | contract | |
| | CBDC | SNAP | CBDC | SNAP | CBDC | SNAP | CBDC | SNAP |
| Entry | 1,000 | 800 | 9,000 | | 200 | | 800 | |
| 1 | | (+100 | | | | | | |
| | | offline | | | | | | |
| | | on | | | | | | |
| | | TEE) | | | | | | |
| Entry | 1,000 | 900 | 9,000 | | 100 | | 900 | |
| 2 | | (+0 | | | | | | |
| | | offline | | | | | | |
| | | on | | | | | | |
| | | TEE) | | | | | | |

Embodiments of the disclosure have a number of advantages. For example, users can access online and offline program tokens for use in program related interactions. Embodiments reduce the risk of a user needing to keep track of and not lose a card that has program currency loaded onto the card.

Further, embodiments allow for seamless conversion of program tokens to CBDC during an interaction between a user and resource provider without the resource provider needing to know that program tokens are being used. In effect, embodiments of the invention can allow users to use both offline cryptocurrencies and program tokens in a secure manner, but with the ease of physical currencies and physical program tokens, while ensuring that transactions are electronically recorded and verified.

Additional details regarding offline payment interactions can be found in U.S. patent application Ser. No. 18/005,054, which is a National Stage of International Application No. PCT/US2021/042645, which claims the benefit of U.S. Provisional Patent Application Nos. 63/055,761, filed on Jul. 23, 2020, 63/090,104, filed on Oct. 9, 2020, and 63/125,305, filed on Dec. 14, 2020, which are incorporated by reference in their entirety for all purposes.

Although the steps in the flow diagrams and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a user device, an interaction request message for an interaction, the interaction request message comprising a requested amount from a resource provider computer;
selecting, by a secure element on the user device, between an offline balance and an offline amount of program tokens stored in the secure element, wherein the offline amount of program tokens is selected;
deducting, by the secure element on the user device, the requested amount from the offline amount of program tokens; and
completing, by the user device, the interaction with the resource provider computer.

2. The method of claim 1 further comprising:
generating, by the user device, a program token request message comprising a requested number of program tokens;
providing, by the user device, the program token request message to a service provider computer, wherein the service provider computer determines whether or not a user of the user device has an online amount of program tokens as indicated by a program smart contract referenced by an offline interaction system smart contract;
receiving, by the secure element of the user device, a program token response message indicating the requested number of program tokens from the service provider computer; and
increasing, by the secure element of the user device, the offline amount of program tokens by the requested number of program tokens.

3. The method of claim 1, wherein the interaction occurs between the user device and the resource provider computer for one or more resources, wherein the user device and the resource provider computer are both enrolled in a program associated with the program tokens.

4. The method of claim 1, wherein the program tokens are created by a program computer as indicated by a program smart contract that references a central authority smart contract, wherein the program computer assigns the program tokens to a user of the user device in the program smart contract.

5. The method of claim 1 further comprising:
receiving, by the user device, a program token creation message from a program computer, wherein the program token creation message indicates that the program token created one or more program tokens that are assigned to the user device and/or a user of the user device as indicated in a program smart contract.

6. The method of claim 1, wherein completing the interaction with the resource provider computer comprises:
generating, by the user device, an interaction response message comprising an amount equal to the requested amount; and
transmitting, by the user device, the interaction response message to the resource provider computer.

7. The method of claim 6, wherein the resource provider computer receives the interaction response message and increases a resource provider offline balance based on the amount.

8. The method of claim 1 further comprising:
generating, by the user device, a program token transfer message comprising a number of program tokens;
providing, by the user device, the program token transfer message to a service provider computer, wherein the service provider computer provides the program token transfer message to a program smart contract stored on a blockchain, wherein the program smart contract, in conjunction with an offline interaction smart contract stored on the blockchain, increase an online balance associated with the user device based on the number of program tokens;
receiving, by the user device, a transfer completion message from the service provider computer.

9. The method of claim 1, wherein the interaction request message further comprises a program eligibility indicator, and wherein the selection between the offline balance and the offline amount of program tokens is based on the program eligibility indicator.

10. The method of claim 1 further comprising:
after receiving the interaction request message, determining, by the secure element of the user device, whether or not there is a first sufficient amount of the offline amount of program tokens in the secure element and/or a second sufficient amount of the offline balance to satisfy the requested amount.

11. The method of claim 10 further comprising:
if there is not the first sufficient amount of the offline amount of program tokens in the secure element to satisfy the requested amount, wherein the offline amount of program tokens is nonzero, applying, by the secure element of the user device, the offline amount of program tokens to the requested amount to determine a remaining amount; and
applying, by the secure element of the user device, the offline balance to the remaining amount.

12. A user device comprising:
a processor; and
a computer-readable medium coupled to the processor, the computer-readable medium comprising code executable by the processor for implementing a method comprising:
receiving an interaction request message for an interaction, the interaction request message comprising an amount from a resource provider computer;
selecting, by a secure element on the user device, between an offline balance and an offline amount of program tokens stored in the secure element, wherein the offline amount of program tokens is selected;
deducting, by the secure element on the user device, the amount from the offline amount of program tokens; and
completing the interaction with the resource provider computer based on the amount.

13. The user device of claim 12, wherein the interaction request message further comprises a program eligibility indicator, and wherein the selection between the offline balance and the offline amount of program tokens is based on the program eligibility indicator, and wherein the method further comprises:
after receiving the interaction request message, if the program eligibility indicator indicates that the interaction is eligible for program tokens, determining whether or not there is a first sufficient amount of the offline amount of program tokens in the secure element and/or a second sufficient amount of the offline balance to satisfy the requested amount.

14. The user device of claim 12, wherein completing the interaction with the resource provider computer comprises:
generating an interaction response message comprising the amount equal to the requested amount and a user device secure element certificate; and
transmitting the interaction response message to the resource provider computer, wherein the resource provider computer receives the interaction response message and increases a resource provider offline balance based on the amount.

15. The user device of claim 12 further comprising:
the secure element, wherein the secure element securely processes cryptographic operations for the user device.

16. The user device of claim 12, wherein the user device and the resource provider computer are offline from a trusted third party computer.

17. A method comprising:
generating, by a resource provider computer, an interaction request message for an interaction, the interaction request message comprising a requested amount;
transmitting, by the resource provider computer, the interaction request message to a user device, wherein a secure element on the user device selects between an offline balance and an offline amount of program tokens stored in the secure element, and wherein the secure element on the user device deducts the amount from the offline amount of program tokens and generates an interaction response message;
receiving, by the resource provider computer, the interaction response message from the user device, wherein the interaction response message comprises an amount equal to the requested amount; and
completing, by the resource provider computer, the interaction with the user device based on the amount.

18. The method of claim 17, wherein the secure element is a first secure element, wherein completing the interaction with the user device comprises:
increasing, by a second secure element on the resource provider computer, a resource provider offline balance based on the amount.

19. The method of claim 17 further comprising:
generating, by the resource provider computer, a transfer message comprising a transfer amount of the offline balance;
deducting, by the resource provider computer, the transfer amount from the offline balance;
providing, by the resource provider computer, the transfer message to a service provider computer, wherein the service provider computer provides the transfer message to an offline interaction smart contract stored on a blockchain, wherein the offline interaction smart contract increases an online balance associated with the resource provider computer based on the transfer amount; and
receiving, by the resource provider computer, a transfer completion message from the service provider computer.

20. The method of claim 17, wherein the interaction occurs between the user device and the resource provider computer for one or more resources, wherein the user device and the resource provider computer are both enrolled in a program associated with the program tokens.
